(19) United States
(12) Patent Application Publication
(10) Pub. No.: US 2021/0200997 A1
(43) Pub. Date: Jul. 1, 2021

(54) Method and system for improving multi-angle face recognition accuracy

(71) Applicant: ANHUI ZHICHUAN TECHNOLOGY CO., LTD., Anhui (CN)

(72) Inventors: Peijin LIU, Anhui (CN); Kun ZHANG, Anhui (CN); Yongqiang YIN, Anhui (CN); Ruichao QI, Anhui (CN); Bingrong NIE, Anhui (CN); Youzhi MA, Anhui (CN)

(73) Assignee: ANHUI ZHICHUAN TECHNOLOGY CO., LTD., Anhui (CN)

(21) Appl. No.: 16/307,488

(22) PCT Filed: Oct. 31, 2018
(86) PCT No.: PCT/CN2018/112983

§ 371 Date: Dec. 6, 2018

(30) Foreign Application Priority Data
Oct. 29, 2018 (CN) 201811270379.2

(51) Int. Cl. G06K 9/00

(52) U.S. Cl. CPC G06K 9/00288

(57) ABSTRACT

The present application proposes a method and system for improving the multi-angle face recognition accuracy, comprising: performing image collection on the face from N preset collection positions, and obtaining N face comparison images; respectively extracting the background parameters of the N face comparison images, comparing the background parameters with the M preset background parameter intervals, and respectively storing the N face comparison images into the corresponding face comparison image set of the M preset background parameter intervals according to the comparison result; collecting a real-time image of the target face; extracting target background parameters in the real-time image of the target face, comparing the target background parameter with the M preset background parameter intervals, and performing face recognization comparison on the real-time image of the target face corresponding to the target background parameter and the face comparison image in the face comparison image set corresponding to the M background parameter intervals according to the comparison result, then outputting face comparison recognition result.

This application claims priority to Chinese Patent Application No. 201811270379.2, filed to the Chinese Patent Office on Oct. 29, 2018, entitled “Method and system for improving multi-angle face recognition accuracy”, the entire disclosure of which is incorporated herein by reference.

### BACKGROUND

### Technical Field

The present invention relates to the field of face recognition technologies, and in particular, to a method and system for improving multi-angle face recognition accuracy.

### Background Art

At present, with the maturity of cameras, algorithms, data volume and other conditions, face recognition technology has gradually become a kind of underlying application tool technology, which has been popularized. It is no longer rare to use face recognition technology to realize attendance management and security verification. The basic principle is as follows: the facial data of the passing crowd is collected by the camera equipment, and which is compared with the facial data pre-stored by the system, thereby realizing identity verification and recognition judgment. However, the face images collected at different angles vary greatly. If the angle of collection of the face image is different from that of the face comparison image, it is clearly the same person, but the comparison result is prone to errors. How to achieve the improvement of recognition accuracy is a problem that needs to be solved in this field.

### SUMMARY OF THE INVENTION

Based on the technical problems existing in the background art, the present application proposes a method and system for improving the multi-angle face recognition accuracy.

The present application proposes a multi-angle face recognition accuracy improvement method comprises:

S1. performing image collection on the face from N preset collection positions, and obtaining N face comparison images;

S2. respectively extracting the background parameters of the N face comparison images, comparing the background parameters with the M preset background parameter intervals, and respectively storing the N face comparison images into the corresponding face comparison image set of the M preset background parameter intervals according to the comparison result;

S3. collecting a real-time image of the target face;

S4. Extracting target background parameters in the real-time image of the target face, comparing the target background parameter with the M preset background parameter intervals, and performing face recognization comparison on the target face real-time image corresponding to the target background parameter and the face comparison image in the M background parameter intervals according to the comparison result, then outputting face comparison recognition result.

Preferably, in S2, the background parameter specifically includes background contrast, background brightness, or background and character ratio.

Preferably, S2 specifically includes:

S21. Extracting background parameters of any one of the N face comparison images;

S22. Comparing the background parameter with the M preset background parameter intervals, and determine a background parameter interval in which the background parameter falls;

S23. storing the face comparison image corresponding to the background parameter in the face comparison image set corresponding to the background parameter interval in which the background parameter falls;

S24. repeating S21 to S23 until the N face comparison images are all stored in the face comparison image set, where M≥N.

Preferably, S4 specifically includes:

S41. extracting target background parameters from a real-time image of the target face;

S42. comparing the target background parameter with the preset M background parameter intervals, and determining a background parameter interval in which the target background parameter falls;

S43. performing face recognization comparison on the real-time image of the target face corresponding to the target background parameter and the face comparison image in the face comparison image set corresponding to the background parameter interval in which the target background parameter falls, and outputting the face comparison recognition result.

A multi-angle face recognition accuracy improvement system, wherein comprising:

comparison image collection module, configured to perform image collection on the face from the N preset collection positions, to obtain N face comparison images;

comparison image classification module, configured to respectively extract the background parameters of the N face comparison images, compare the background parameters with the M preset background parameter intervals, and respectively store the N face comparison images in the face comparison image sets corresponding to the M background parameter intervals according to the comparison result;

real-time image collection module, configured to collect real-time images of target face;

image recognition module, configured to extract target background parameter in the real-time image of the target face, compare the target background parameter with M preset background parameter intervals, and perform face recognization comparison on the target face real-time image corresponding to the target background parameter and the face comparison image in the face comparison image set corresponding to the M background parameter intervals according to the comparison result, and output face comparison result.

Preferably, the comparison image classification module is specifically used; the background parameter includes one of background contrast, background brightness, and background and character ratio.

Preferably, the comparison image classification module comprises an extraction unit, a determination unit, a storage unit and a loop unit;

the extracting unit, configured to receive a face comparison image, and extract a background parameter of the face comparison image;

the determining unit, configured to compare the background parameter with M preset background parameter intervals, and determine the preset background parameter interval in which the background parameter falls;

the storage unit, configured to store the face comparison image corresponding to the background parameter in the face comparison image set corresponding to the preset background parameter interval in which the background parameter falls;

the loop unit, configured to send a face comparison image to the extracting unit until all the N face comparison images are stored in the face comparison image sets.

Preferably, the image recognition module is specifically configured to:

extract target background parameters from a real-time image of the target face;

compare the target background parameter with the M preset background parameter intervals, and determining a background parameter interval in which the target background parameter falls;

perform face recognization comparison on the real-time image of the target face corresponding to the target background parameter and the face comparison image in the face comparison image set corresponding to the background parameter interval in which the target background parameter falls, and outputting the face comparison recognition result, and outputting face comparison recognition result.

In the present application, it is included that collecting firstly person comparison images from a plurality of collection visual angles, storing the face comparison images respectively in the corresponding face comparison image set according to the background parameter of the face comparison image, collecting the real-time image of the target face, extracting the target background parameter in the real-time image of the target face, performing face recognization comparison on the real-time image of the target face corresponding to the target background parameter and the face comparison image corresponding to the M background parameter intervals, and outputting the face comparison recognition results. In this way, according to the difference of the background parameters of the face comparison image, the face comparison image of the same visual angle or the same scene is stored in the corresponding face comparison image set. After obtaining the real-time image of the target face, according to the target background parameter of the real-time image of the target face, the face recognition comparison image set is determined, and the face recognition comparison is performed, which greatly reduces the face recognition error caused by different visual angles or scenes, and improves face recognition accuracy, at the same time, the number of comparisons is reduced and the efficiency of face recognition is improved.

### BRIEF DESCRIPTION OF DRAWING

FIG. 1 is a schematic flow chart of a multi-angle face recognition accuracy improvement method according to the present application;

FIG. 2 is a schematic block diagram of A multi-angle face recognition accuracy improvement system according to the present application.

### DETAILED DESCRIPTION OF THE EMBODIMENTS

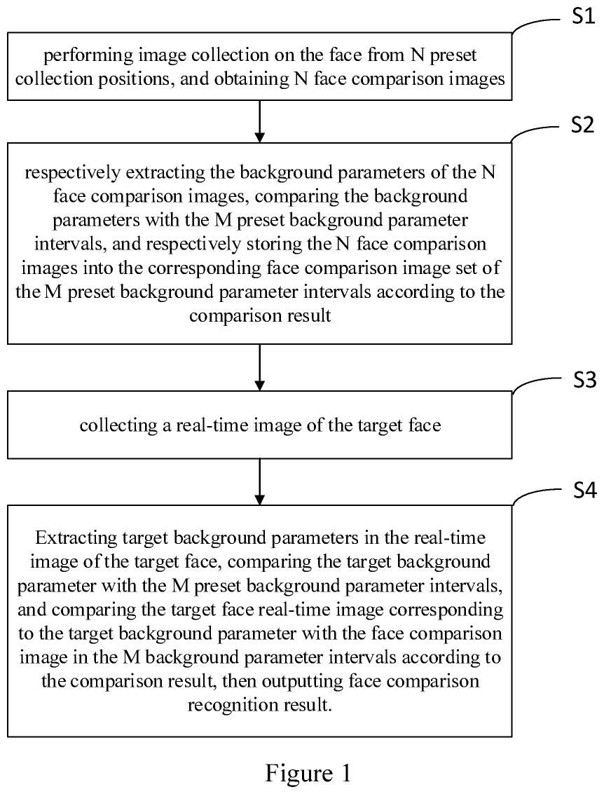

Referring to FIG. 1, The present application proposes a multi-angle face recognition accuracy improvement method comprises:

S1, performing image collection on the face from N preset collection positions, and obtaining N face comparison images.

In a specific embodiment, the image capture device is arranged in different capture positions and capture scenes, and the images are captured for the faces, the images are compared and multiple face comparison images is obtained.

S2, respectively extracting the background parameters of the N face comparison images, comparing the background parameters with the M preset background parameter intervals, and respectively storing the N face comparison images into the corresponding face comparison image set of the M preset background parameter intervals according to the comparison result, wherein the background parameter specifically includes: one of background contrast, background brightness, and background and character ratio.

S2 specifically includes:

S21. Extracting background parameters of any one of the N face comparison images;

S22. Comparing the background parameter with the M preset background parameter intervals, and determine a background parameter interval in which the background parameter falls;

S23. storing the face comparison image corresponding to the background parameter in the face comparison image set corresponding to the background parameter interval in which the background parameter falls;

S24. repeating S21 to S23 until the N face comparison images are all stored in the face comparison image set, where M≥N.

In a specific embodiment, because the positions and scenes of the captured face comparison images are different, the background parameters in the face comparison images, such as background contrast, background brightness, background and character ratio, are also different. the position of the captured image will be different. By extracting the background parameters of the face comparison images, the face comparison images with the same visual angle or the same scene is stored in the corresponding face comparison image set.

S3, collecting a real-time image of the target face.

In a specific embodiment, image collection is performed on the target face through the image capture device, to obtain a real-time image of the target face.

S4, extracting target background parameters in the real-time image of the target face, comparing the target background parameter with the M preset background parameter intervals, and performing face recognization comparison on the target face real-time image corresponding to the target background parameter and the face comparison image in the M background parameter intervals according to the comparison result, then outputting face comparison recognition result.

S4 specifically includes:

S41. Extracting target background parameters from a real-time image of the target face;

S42. Comparing the target background parameter with the preset M background parameter intervals, and determining a background parameter interval in which the target background parameter falls;

S43. performing face recognization comparison on the real-time image of the target face corresponding to the target background parameter and the face comparison image in the face comparison image set corresponding to the background parameter interval in which the target background parameter falls, and outputting the face comparison recognition result.

In a specific embodiment, after obtaining the real-time image of the target face, according to the target background parameter of the real-time image of the target face, the face recognition comparison image set is determined, and the face recognition comparison is performed, which greatly reduces the face recognition error caused by different visual angles or scenes.

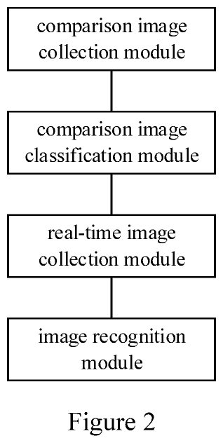

Referring to FIG. 2, the present application proposes a multi-angle face recognition accuracy improvement system, comprising:

comparison image collection module, configured to perform image collection on the face from the N preset collection positions, to obtain N face comparison images.

In a specific embodiment, the image capture device is arranged in different capture positions and capture scenes, and the images are captured for the faces, the images are compared and multiple face comparison images is obtained.

Comparison image classification module is configured to respectively extract the background parameters of the N face comparison images, compare the background parameters with the M preset background parameter intervals, and respectively store the N face comparison images in the face comparison image sets corresponding to the M background parameter intervals according to the comparison result; wherein, the background parameters include one of background contrast, background brightness, and background and face ratio.

The comparison image classification module comprises an extraction unit, a determination unit, a storage unit and a loop unit;

The extracting unit, configured to receive a face comparison image, and extract a background parameter of the face comparison image;

The determining unit, configured to compare the background parameter with M preset background parameter intervals, and determine the preset background parameter interval in which the background parameter falls;

The storage unit, configured to store the face comparison image corresponding to the background parameter in the face comparison image set corresponding to the preset background parameter interval in which the background parameter falls;

The loop unit, configured to send a face comparison image to the extracting unit until all the N face comparison images are stored in the face comparison image sets.

In a specific embodiment, because the positions and scenes of the captured face comparison images are different, the background parameters in the face comparison images, such as background contrast, background brightness, background and character ratio, are also different. the position of the captured image will be different. By extracting the background parameters of the face comparison images, the face comparison images with the same visual angle or the same scene is stored in the corresponding face comparison image set.

Real-time image collection module, configured to collect real-time images of target face.

In a specific embodiment, image collection is performed on the target face through the image capture device, to obtain a real-time image of the target face.

Image recognition module, configured to extract target background parameter in the real-time image of the target face, compare the target background parameter with M preset background parameter intervals, and perform face recognization comparison on the target face real-time image corresponding to the target background parameter and the face comparison image in the face comparison image set corresponding to the M background parameter intervals according to the comparison result, and output face comparison recognition result.

The image recognition module is specifically configured to:

extracting target background parameters from a real-time image of the target face;

comparing the target background parameter with the M preset background parameter intervals, and determining a background parameter interval in which the target background parameter falls;

performing face recognization comparison on the real-time image of the target face corresponding to the target background parameter and the face comparison image in the face comparison image set corresponding to the background parameter interval in which the target background parameter falls, and outputting face comparison recognition result.

In a specific embodiment, after obtaining the real-time image of the target face, according to the target background parameter of the real-time image of the target face, the face recognition comparison image set is determined, and the face recognition comparison is performed, which greatly reduces the face recognition error caused by different visual angles or scenes, and improves face recognition accuracy, at the same time, the number of comparisons is reduced and the efficiency of face recognition is improved.

In the present application, it is included that collecting firstly person comparison images from a plurality of collection visual angles, storing the face comparison images respectively in the corresponding face comparison image set according to the background parameter of the face comparison image, collecting the real-time image of the target face, extracting the target background parameter in the real-time image of the target face, comparing the real-time image of the target face corresponding to the target background parameter with the face comparison image corresponding to the M background parameter intervals, and outputting the face comparison recognition results. In this way, according to the difference of the background parameters of the face comparison image, the face comparison image of the same visual angle or the same scene is stored in the corresponding face comparison image set. After obtaining the real-time image of the target face, according to the target background parameter of the real-time image of the target face, the face recognition comparison image set is determined, and the face recognition comparison is performed, which greatly reduces the face recognition error caused by different visual angles or scenes, and improves face recognition accuracy, at the same time, the number of comparisons is reduced and the efficiency of face recognition is improved.

The above is only the preferred embodiment of the present application, but the scope of protection of the present application is not limited thereto, and any equivalents or modifications of the technical solutions of the present application and the application concept thereof should be included in the scope of the present application within the scope of the technical scope of the present application.

What is claimed is:

1. A multi-angle face recognition accuracy improvement method, characterized by comprising:
S1: performing image collection on the face from N preset collection positions, and obtaining N face comparison images;
S2: respectively extracting background parameters of the N face comparison images, comparing the background parameters with M preset background parameter intervals, and respectively storing the N face comparison images into a corresponding face comparison image set of the M background parameter intervals according to a comparison result;
S3: collecting a real-time image of a target face;
S4: extracting target background parameters in the real-time image of the target face, comparing the target background parameters with the M preset background parameter intervals, and performing face recognization comparison on the real-time image of the target face corresponding to the target background parameters and the face comparison image in the face comparison image set corresponding to the M background parameter intervals according to the comparison result, then outputting face comparison recognition result.

2. The multi-angle face recognition accuracy improvement method according to claim 1, characterized in that, in step S2, the background parameters specifically include background contrast, background brightness, or background and character ratio.

3. The multi-angle face recognition accuracy improvement method according to claim 1, characterized in that, step S2 specifically includes:
S21: Extracting background parameters of any one of the N face comparison images;
S22: Comparing the background parameters with the M preset background parameter intervals, and determine a background parameter interval into which the background parameters fall;
S23: storing the face comparison image corresponding to the background parameters in the face comparison image set corresponding to the background parameter interval into which the background parameters fall;
S24: repeating S21 to S23 until the N face comparison images are all stored in the face comparison image set, where M≥N.

4. The multi-angle face recognition accuracy improvement method according to claim 1, characterized in that, step S4 specifically comprises:
S41: extracting target background parameters from a real-time image of the target character;
S42: comparing the target background parameters with the preset M background parameter intervals, and determining a background parameter interval into which the target background parameters fall;
S43: comparing the real-time image of the target face corresponding to the target background parameter and the face comparison image in the face comparison image set corresponding to the background parameter interval into which the target background parameters fall, and outputting the face comparison recognition result.

5. A multi-angle face recognition accuracy improvement system, characterized by comprising:
comparison image collection module, configured to perform image collection on the face from N preset collection positions, to obtain N face comparison images;
comparison image classification module, configured to respectively extract the background parameters of the N face comparison images, compare the background parameters with M preset background parameter intervals, and respectively store the N face comparison images in the face comparison image sets corresponding to the M background parameter intervals according to the comparison result;
real-time image collection module, configured to collect a real-time image of a target face;
image recognition module, configured to extract target background parameter in the real-time image of the target face, compare the target background parameter with the M preset background parameter intervals, and perform face recognization comparison on the real-time image of the target face corresponding to the target background parameters and the face comparison image in the face comparison image set corresponding to the M background parameter intervals according to the comparison result, and output face comparison recognition result.

6. The multi-angle face recognition accuracy improvement system according to claim 5, characterized in that, the comparison image classification module is specifically used; the background parameter includes one of background contrast, background brightness, and background and character ratio.

7. The multi-angle face recognition accuracy improvement system according to claim 5, characterized in that, the comparison image classification module comprises an extraction unit, a determination unit, a storage unit and a loop unit;
the extracting unit, configured to receive a face comparison image, and extract the background parameters of the face comparison image;
the determining unit, configured to compare the background parameters with the M preset background parameter intervals, and determine the preset background parameter interval into which the background parameters fall;
the storage unit, configured to store the face comparison image corresponding to the background parameter in the face comparison image set corresponding to the background parameter interval into which the background parameters fall;
the loop unit, configured to send a face comparison image to the extracting unit until all the N face comparison images are stored in the face comparison image sets.

8. The multi-angle face recognition accuracy improvement system according to claim 5, characterized in that, the image recognition module is specifically configured to:
extract target background parameters from the real-time image of the target face;
compare the target background parameter with the M preset background parameter intervals, and determining a background parameter interval in which the target background parameter falls;
comparing the real-time image of the target face corresponding to the target background parameter and the face comparison image in the face comparison image set corresponding to the background parameter interval into which the target background parameters fall, and outputting the face comparison recognition result.
